(19) United States
(12) Patent Application Publication
(10) Pub. No.: US 2003/0091966 A1
(43) Pub. Date: May 15, 2003

(54) Excercise/simulation device

(76) Inventor: David J. Collodi, Taylorville, IL (US)

Correspondence Address: William F. Prendergast, c/o Brinks Hofer Gilson & Lione, NBC Tower, Suite 3600, P.O. Box 10395, Chicago, IL, 60610, US

(21) Appl. No.: 10/294,116

(22) Filed: Nov. 14, 2002

Related U.S. Application Data
(60) Provisional application No. 60/333,111, filed on Nov. 14, 2001.

(51) Int. Cl. G09B 9/00; G09B 19/00; A63B 69/00

(52) U.S. Cl. 434/247; 434/307 R; 434/365

(57) ABSTRACT

An exercise device allowing a free range of human motion coupled with an interactive computer system to provide visual feedback based on head and body motion. The operator of the device rests on a central support frame that rotates about a vertical axis. Each of the operator's feet is placed in a multi-jointed leg apparatus that provides a full range of motion and rotation about all three axes. Each leg apparatus contains a contact braking mechanism that provides resistance sufficient to enable the central frame to pivot about its axis. Arm mechanisms with hand grips are grasped by the operator's hands and provide a full range of arm movement and rotation. The operator wears a head-mounted display unit on his head capable of tracking the position and rotation of his head and providing an interactive video image. Electronic sensors are operatively placed to measure the position and rotation of the operator's hands, feet, and head as well as the rotation of the central frame.

### RELATED APPLICATION

This application claims the benefit of the filing date pursuant to 35 U.S.C. §119(e) of Provisional Application Serial No. 60,333,111, filed Nov. 14, 2001, the disclosure of which is hereby incorporated by reference.

### BACKGROUND OF THE INVENTION

Many prior art examples of motion based cardiovascular exercise devices currently exist, as well as several devices that combine human motion with computer interactivity. Stationary and recumbent bicycles have previously existed and have recently been combined with interactive computer displays which can enhance the experience through the introduction of interactivity and the pursuit of visually presented goals. While these systems work well for the purposes they are intended, they do limit interactivity to the specific range of motion provided by bicycle devices, namely opposed, circular leg movement about a fixed axis.

Other devices attempt to simulate a natural walking or climbing motion such as stair-stepping devices, treadmills, and elliptical training devices. Stair-stepping devices provide a resistance-based, linear vertical motion for the operator's legs, stimulating the muscle groups employed in vertical ascent. Some recent attempts have been made to expand the effectiveness of such devices by adding a horizontal linear track of motion to each leg and providing interactivity through a worn display device. Treadmills allow the operator to perform a normal, unrestricted walking motion in the forward direction. The rate of movement can be either monitored, controlled or both by the treadmill device. Treadmills may be optionally combined with a display device to heighten interactivity. Elliptical training devices provide foot pedals which move in an elliptical path along a horizontal, latitudinal axis which allow for the operator to perform somewhat of a walking motion while in a standing position and resting his or her hands on one or more handle bars. Similar devices provide foot pedals attached to leg apparatuses that swing about a waist high latitudinal axis. These devices simulate a striding motion where the operators swing their legs in opposing directions along a fixed path. Other similar devices simulate linear leg motions in such activities as ice skating and cross country skiing. Such devices, however, focus on a single activity or a small range of activities and restrict the operator from performing more complicated motions. Likewise, none of the devices allow for the body to rotate.

A prior art device consisting of three interconnected concentric circles allows the operator to rotate his or her body about all three axes. However, the operator's arms and legs, however, are constrained to a fixed position. Another prior art apparatus, which is less geared towards cardiovascular exercise, allows the operator to stand and turn in a small fixed enclosure wherein the position and rotation of a “gun” carried by the operator is electronically measured. Likewise the operator wears a head-mounted display unit whose rotation is also electronically measured. While such an apparatus provides the operator with some degree of freedom, he or she is restricted from performing walking and running motions. Likewise, the positions and rotations of the operator's feet are not monitored.

While each of the aforementioned prior art devices excels at providing a limited range of motion and activity, none of them, on their own, are capable of simulating a broad range of human athletic activity. There exists a need, therefore, for a device capable of simulating the general purpose lower-body motions of walking, turning, running and jumping while also providing for a broad range of upper body movement as well. The present invention detailed herein describes an exercise device capable of providing a nearly full range of both lower-body and upper-body motion while restricting travel and providing a mechanism to measure the position and rotation of the operator's hands, feet, torso, and head and providing an interactive visual feedback system dependent on said measurements.

### BRIEF SUMMARY OF THE INVENTION

The present invention describes a motion-based device coupled with a computing element and a display unit to provide interactive visual feedback dependent on the operator's body movement.

According to a first aspect of the invention, a simulation device for use by an operator is provided. The simulation device includes a stationary base and a central frame rotatably connected to the base. A first foot support rotatable around at least three axes is connected to the central frame. A second foot support rotatable around at least three axes is also connected to the frame. An arm support is further connected to the central frame.

According to a further aspect of the invention, a simulation system is provided. The system includes a motion device for use by an operator allowing the operator to perform the motions of walking, running, and turning while restricting the operator from traveling. A plurality of sensors operable to detect the relative position and rotation of the operator's feet and head are also connected to the system. A visual display capable of being connected to the operator's head is provided and a computing device is operatively connected to the plurality of sensors and the visual display. The computing device is capable of generating a display signal for the visual display using information provided by the sensors.

### BRIEF DESCRIPTION OF SEVERAL VIEWS OF THE DRAWINGS

FIG. 1 is an illustration of an upper rear perspective view of an embodiment of the present invention.

FIG. 2 is an illustration of an upper front perspective of the embodiment of FIG. 1.

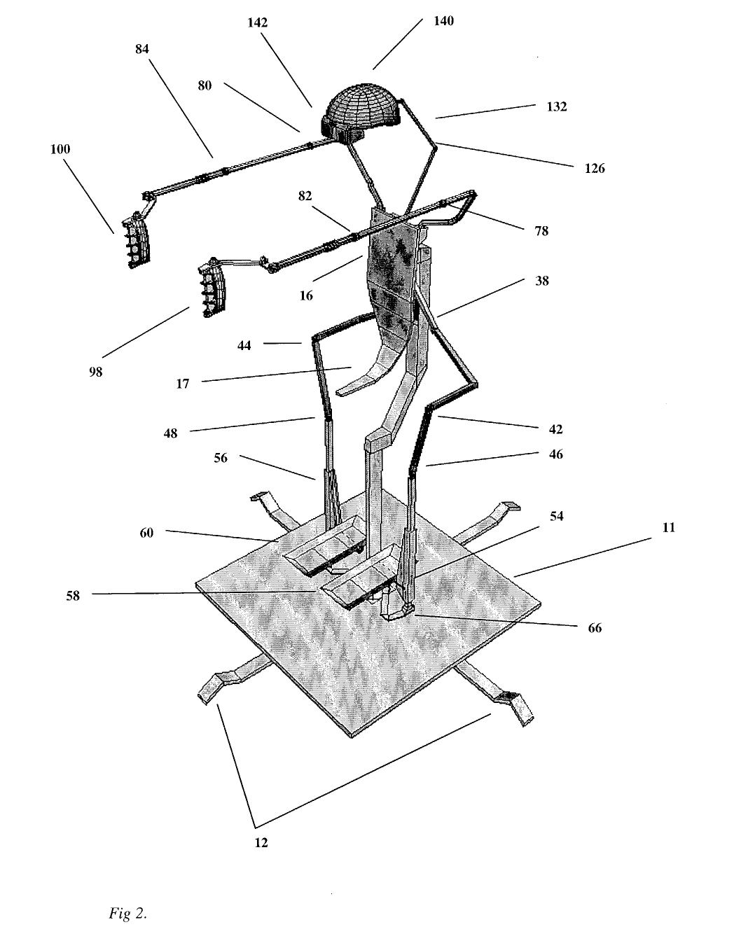

FIG. 3 is an illustration of a side view of the embodiment of FIG. 1.

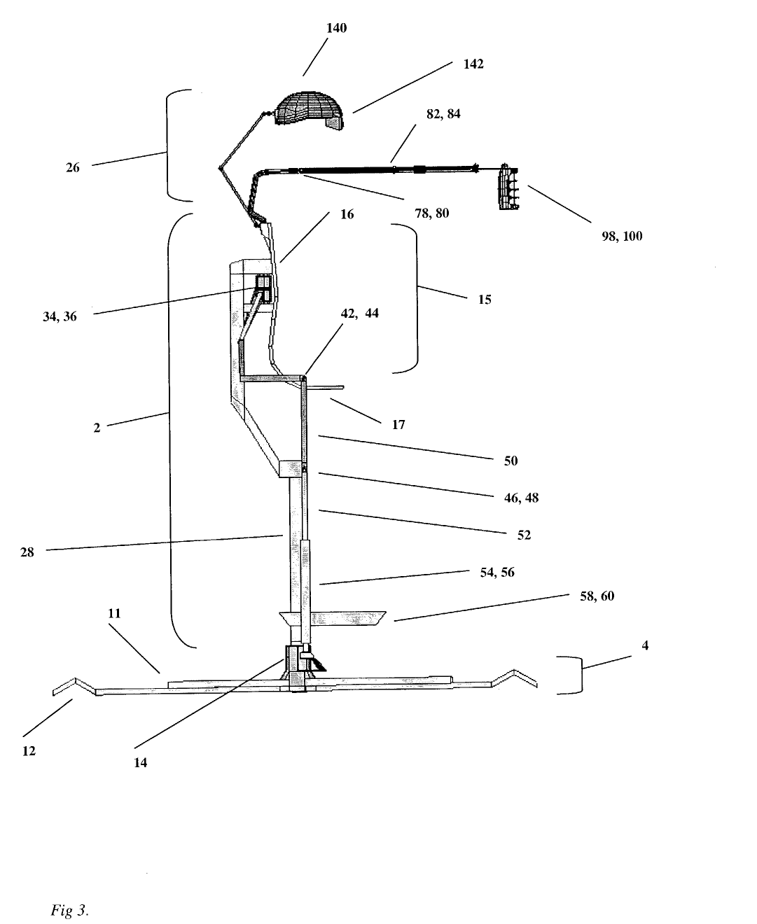

FIG. 4 is an illustration of a rear view of the embodiment of FIG. 1.

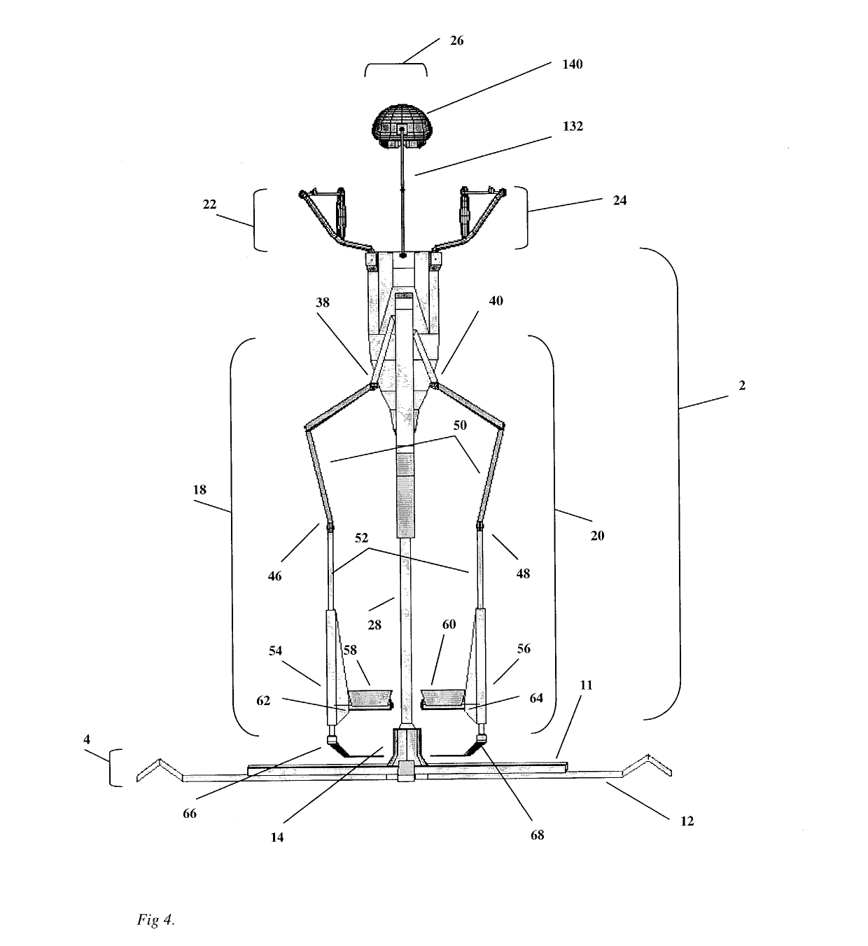

FIG. 5 is an illustration of an enlarged view of a lower portion of the embodiment of FIG. 1.

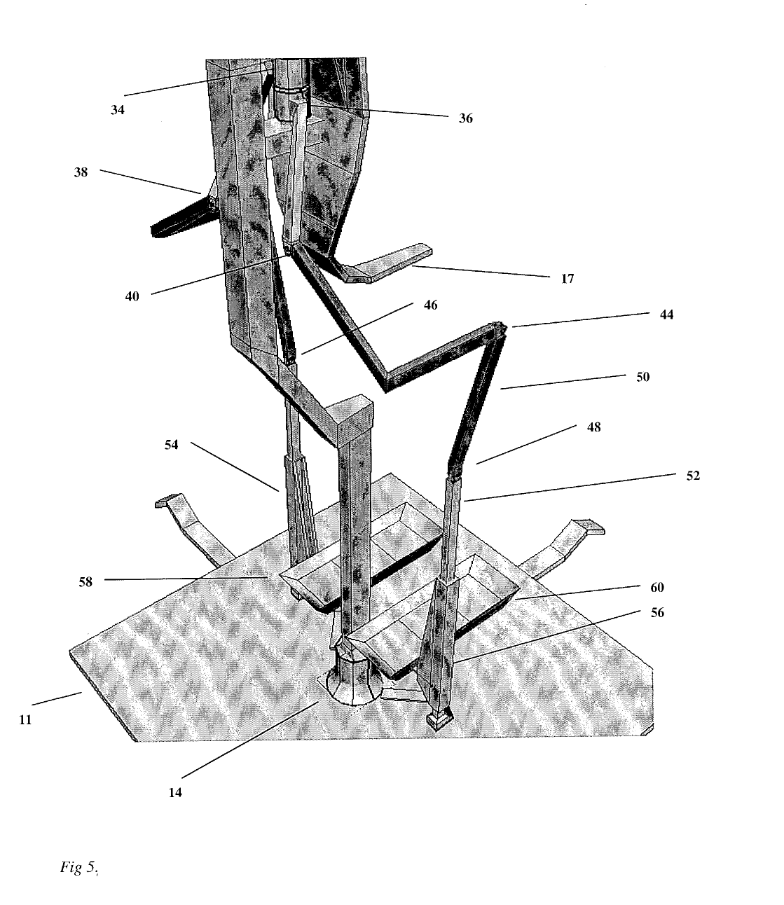

FIG. 6 is an illustration of a foot assemblies of the embodiment of FIG. 1.

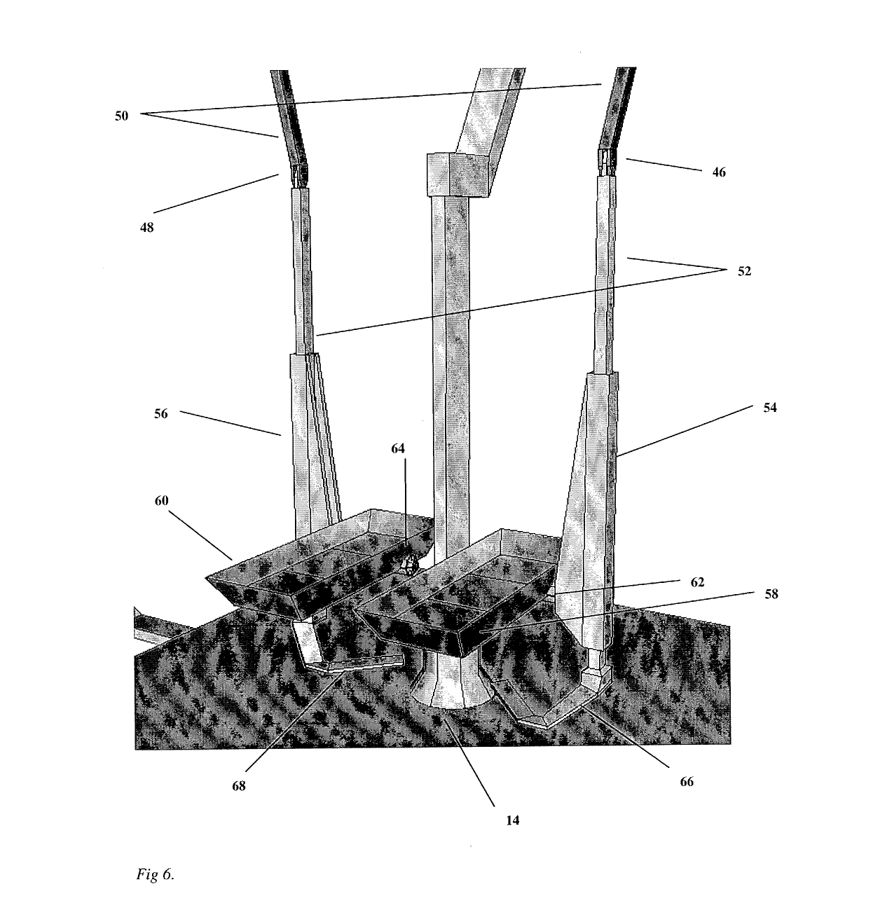

FIG. 7 is an illustration of an arm support of the embodiment of FIG. 1.

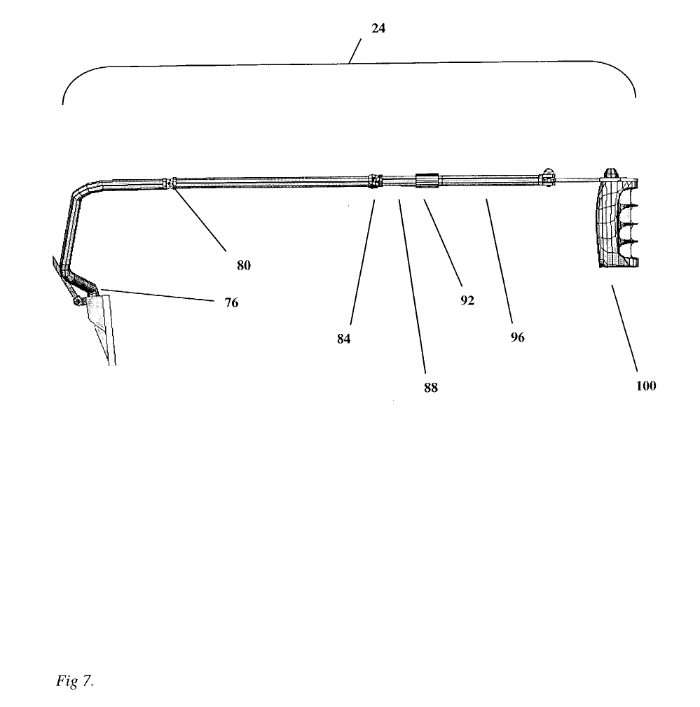

FIG. 8 is an illustration of the left and right grips of the embodiment of FIG. 1.

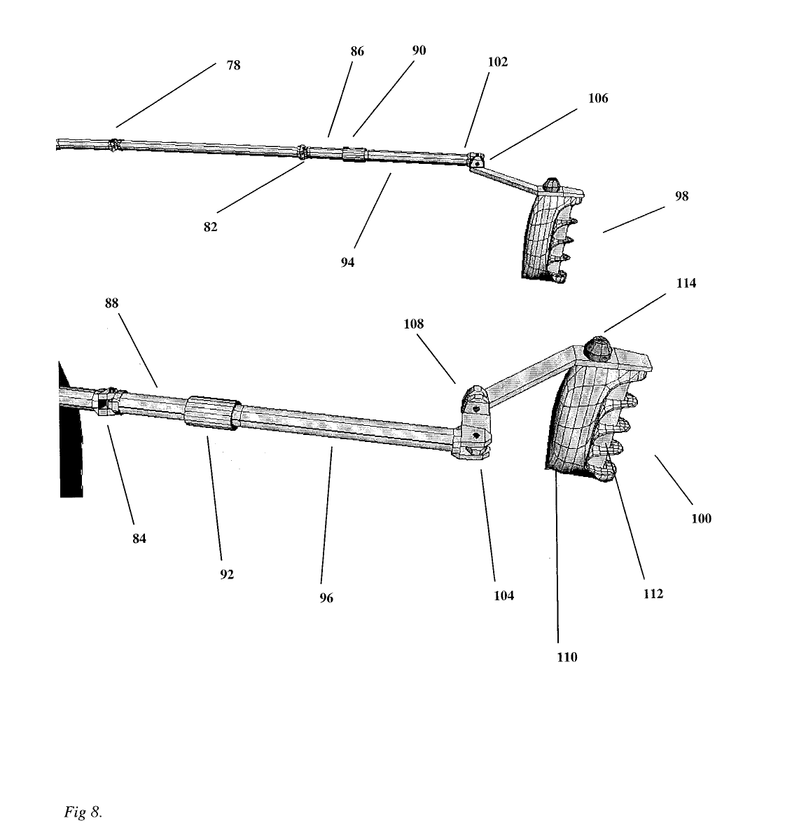

FIG. 9 is an illustration of a rear view of the positional assembly of the embodiment of FIG. 1.

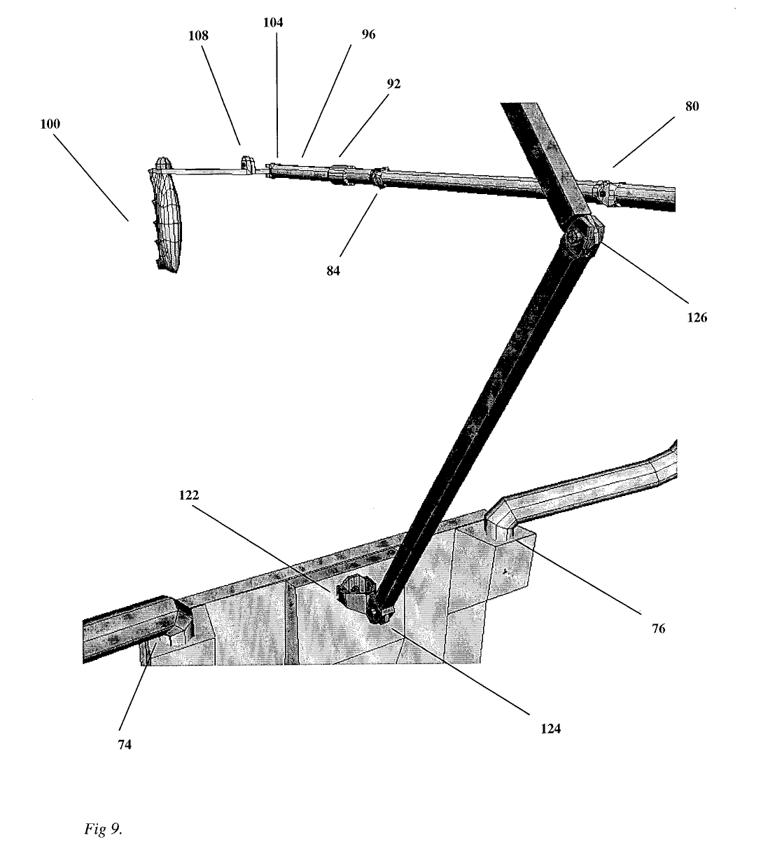

FIG. 10 is an illustration of the helmet and rotational joints of the embodiment of FIG. 1.

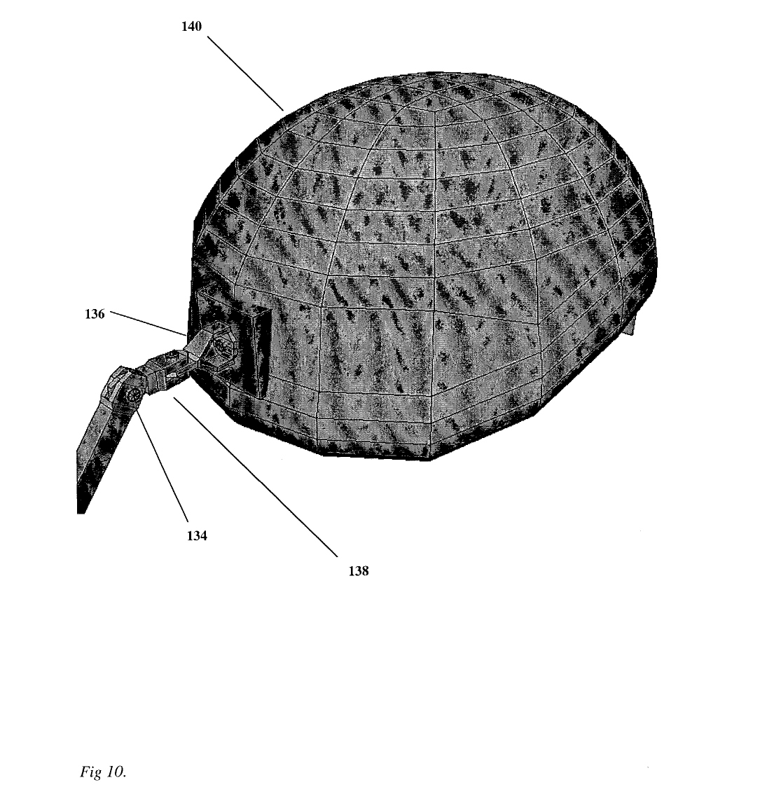

FIG. 11 is an illustration of a side view of the helmet, visor, and rotational joints of the embodiment of FIG. 1.

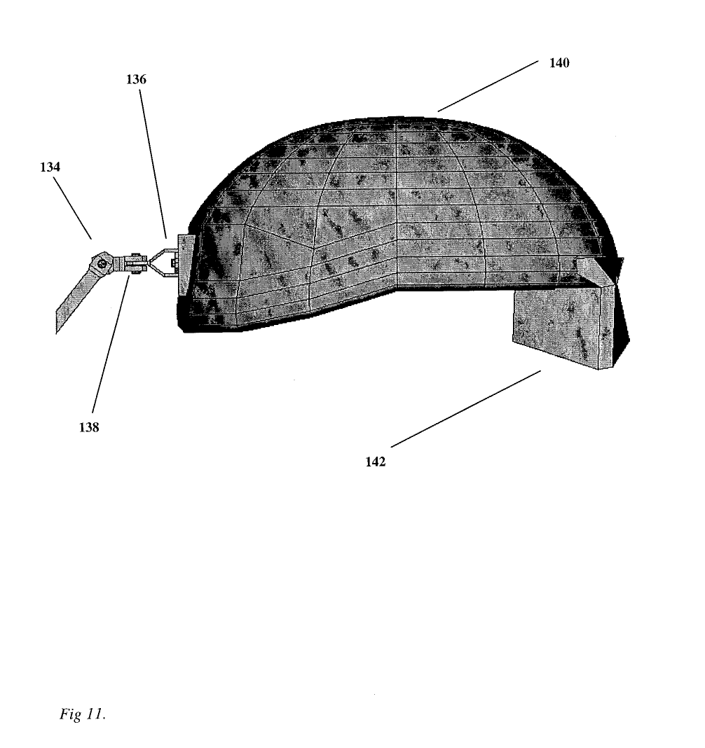

FIG. 12. illustrates a perspective view of an alternate embodiment of the present invention.

### DETAILED DESCRIPTION OF THE INVENTION

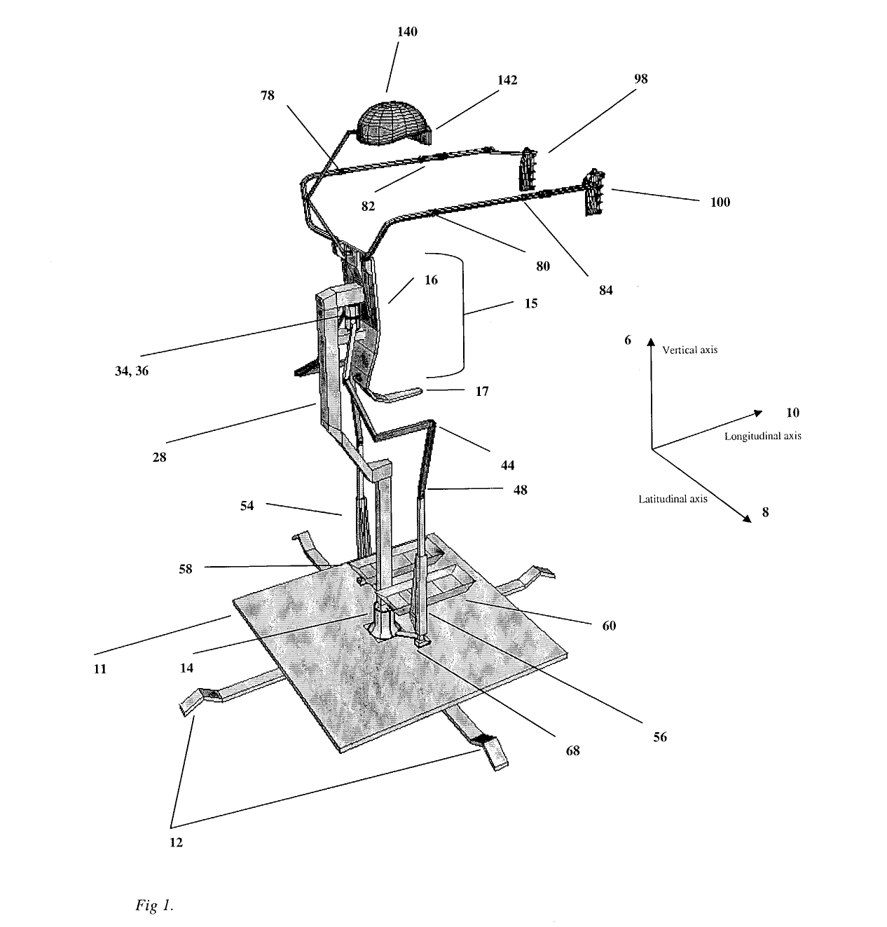

FIG. 1 depicts a perspective view of an exercise/simulation device 10 in accordance with a first embodiment. FIG. 1 depicts an angled view of the device of the present invention along with a set of rotation axes (6, 8, 10) useful in describing the rotations of various joints within the present invention. In reference to FIG. 1, the term yaw will henceforth be used to describe rotations about the vertical axis (6). Likewise, the terms pitch and roll will henceforth be used to described rotations about the latitudinal (8) and longitudinal (10) axes respectively. It should be noted that descriptions of joint rotations presented in the following disclosure are given relative to the joint orientation depicted in the accompanying illustrations. This is done for the purpose of presenting a clear example and it should be recognized by those in that art that the rotation axis of a joint, relative to the base of the device, may change dependant on the rotation(s) of its parent joint(s).

The exercise/simulation device 10 has a central frame (2) and the base (4). The base surface (11) has two or more support bars (12) for stability and a rotation mount (14). The base surface (11) rests on level ground with the support bars (12) providing a torque balance to keep the device from tipping over. The base surface (11) is useful for two purposes, to provide a raised surface allowing the operator to get on the device more easily and to provide a source of friction to facilitate the rotation of the central frame. The central frame (2) is attached to the base surface (11) via a swivel joint at the rotation mount (14). The swivel joint allows the central frame (2) to pivot about the vertical axis (yaw) (6). The swivel joint must be strong enough to bear the weight of the central frame while reducing friction sufficiently to allow the central frame (2) to rotate freely about the base surface (11). Numerous examples of suitable low-friction swivel joints are well known to those skilled in the applicable art.

The central frame (2) consists of a seating assembly (15), a left and right leg apparatus (18, 20), a left and right arm apparatus (22, 24) and a head mounted display assembly (26). The seating assembly (15) comprises a back plate (16) and a seat (17). The back plate (16) provides support for the operator's lower and middle back. The seat (17) is narrow, like a bicycle seat, to allow a free range of leg movement and is meant to support the operator's body weight in situations where both of the operator's legs are raised. In a standing position, most of the operator's body weight will be applied to the leg apparatuses and not the seating assembly. Although not shown in the illustrations, a preferred embodiment of the present invention has a padded surface on the seat (17). In the example embodiment, the back plate (16) and seat (17) are connected. However, in alternate embodiments the seat (17) is removable. In such alternate embodiments, padded support bars may be placed under the operator's shoulders to support his/her body weight. While the back plate (16) and seat (17) provide support in the rearward and downward directions, additional support may be necessary for the forward and lateral directions. A preferred embodiment of the present invention also provides an adjustable restraining belt that extends across the operator's mid torso and attaches to both sides of the back plate (16). Like a seat belt in an automobile, the restraining belt can be tightened to comfortably fit each operator and provides additional forward and lateral stability. In alternate embodiments, a positionable support bar pressed against the operator's mid torso is used to provide forward and lateral stability.

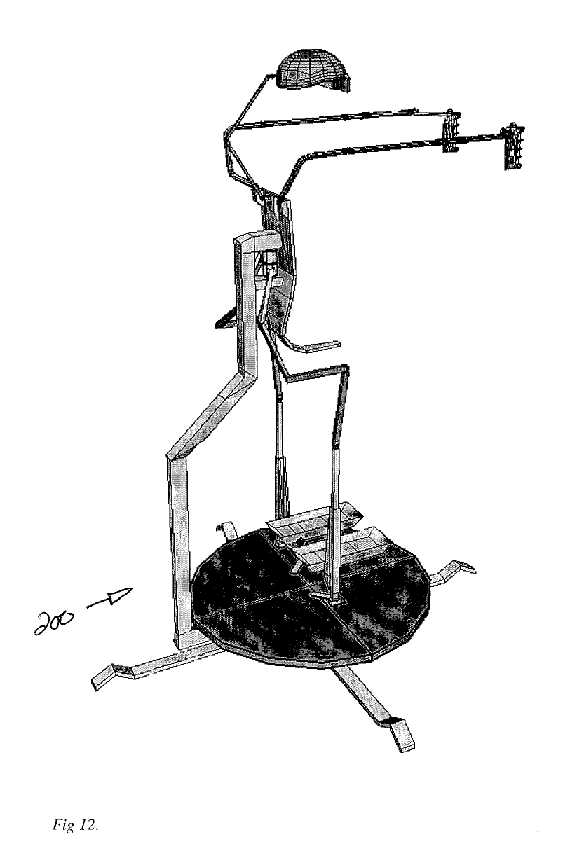

The seating assembly (15) is connected to a central support bar (28). The central support bar (28) connects via the swivel joint to the rotation mount at (14). In a preferred embodiment, the central support bar (28) extends vertically from the rotation mount to about knee level and then curves rearward. The present invention allows for substantial freedom for leg movements while providing a mainly centralized weight distribution permitting easier rotation about swivel joint. The centrally located support bar (28), however, does restrict cross lateral leg movements. FIG. 12 illustrates an alternate embodiment (200) of the present invention where the central support bar extends rearward behind the base surface and the swivel joint and rotation mount are placed underneath the base surface. The alternate embodiment (200) depicted in FIG. 12 provides for unrestricted cross lateral leg movement at the cost of an increased moment of rotation for the central frame.

Left and right leg apparatuses (18, 20) are connected to the central frame (2) by leg swivel joints at (34) and (36) which rotate about the vertical axis (6). The leg swivel joints (34, 36) are aligned so each leg apparatus swivels independently around the same axis. In the example embodiment, the swivel joints are placed near to the rotation axis of the central frame (2) in order to facilitate turning motions wherein one leg will remain (nearly) aligned with the base during the rotation of the central frame. In alternate embodiments, the leg swivel joints are placed underneath the seat in alignment to the central frame's axis of rotation. While the leg swivel joints allow the leg apparatuses to be rotated around the vertical axis, leg roll joints at (38) and (40) allow for rotation around the longitudinal axis. The leg roll joints(38, 40) are placed behind the operator's hips to provide a natural arc of rotation while keeping the joints and connecting bars away from the operator's body at all times. Leg pitch joints at (42) and (44) allow the leg apparatuses to be rotated around the latitudinal axis. Like the leg roll joints (38, 40), the leg pitch joints (42, 44) are (substantially) aligned with the operator's hips to provide a natural arc of rotation while simultaneously placed far enough away from the operator's body as to not impair motion. Leg extension joints at (46) and (48) allow each leg apparatus to be extended and distended. The leg extension joints (46, 48), like the leg pitch joints (42, 44), also rotate about the latitudinal axis (10) matching the rotation axis of the knees and thereby keeping the joints and connecting bars away from the operator's leg. In a preferred embodiment, the leg extension joints (46, 48) are limited so that the angle between the mid and lower leg bars (50, 52) cannot exceed 180° and the lower leg bar rotates toward the rear of the central frame (opposite of the direction the operator is facing). In alternate embodiments, a sliding mechanism is used in place of the leg extension joints.

Left and right adjustable foot assemblies (54, 56) are placed on the lower leg bars. In a preferred embodiment, the adjustable foot assemblies (54, 56) are able to slide up and down the lower leg bars and may be locked in various positions to allow the device to accommodate operators of different heights. A straightforward method of locking the adjustable foot assemblies (54, 56), employed in a preferred embodiment of the present invention, includes a series of holes along the lower leg bar and a hole of corresponding size on a fixed location in the foot assembly. The operator can align the hole in the foot assembly with a desired hole in the lower leg bar and place a metal rod, angled at one end, through the hole to lock the foot assembly to the desired position. Other embodiments employ alternate methods, well known to those skilled in the art, of locking the adjustable foot assemblies (54, 56). Each adjustable foot assembly contains an attached foot pedal (58, 60) where the operator places his left and right foot respectively. In a preferred embodiment, each foot pedal contains a restraint device to keep the operator's foot attached to the surface of the pedal. A straightforward restraint device provides a strap covering the arch of the foot and an adjustable strap, anchored at the rear of the pedal, extending around the ankle. Other restraint devices, however, may be employed without departing from the scope of the present invention. Ankle yaw joints at (62, 64) allow the foot pedals to rotate around the latitudinal axis.

Left and right contact brakes (66, 68) extend from the left and right lower leg bars (respectively). Each contact brake (66, 68) consists of a diagonal bar aligned parallel to the base. Extensions, made from a pliable material such as foam or rubber, extrude downward from the bottom surface of the diagonal bar in order to make contact with the base surface when the leg apparatus is at near to full extension and at a vertical or near-vertical inclination. The purpose of the contact brake is to create friction between the leg apparatus and the base. The operator may use the generated friction to pivot the central frame about its swivel joint by employing a natural turning motion. Additionally, the friction can provide a natural sense of resistance for walking and running motions. Since only the pliable extensions make contact with the base, the amount of joint impact and stress inherent in walking and running is significantly reduced. The ability of the device to allow the operator to turn in a natural manner significantly contributes to its usefulness in simulating a wide variety of athletic activities.

Left and right arm apparatuses (22, 24) are connected to the back plate by arm swivel joints at (74, 76). The arm swivel joints (74, 76) allow each arm apparatus to rotate about the vertical axis. Arm pitch joints at (78, 80) provide latitudinal axis rotation. Angled arm extension joints (82, 84) permit the operator to extend and distend the arm apparatus. In a preferred embodiment of the present invention, each arm extension joint (82, 84) rotates about a diagonal axis between the latitudinal and vertical axis, allowing the mid arm bars (86, 88) to rotate inward and downward. The diagonal axis of rotation of the arm extension joints (82, 84) serves to keep the arm apparatus away from the operator's arms during exaggerated arm movements. Alternate embodiments of the present invention, however, employ arm extension joints that rotate around different axes. As with the aforementioned leg extension joints, a preferred embodiment limits the rotation of the arm extension joints to 180°. Further alternate embodiments employ a sliding mechanism, as opposed to extension joints, to allow for arm extension and distension. Mid arm roll joints at (90, 92) allow the lower arm bars (94, 96), and the connected hand grips (98, 100), to roll about the longitudinal axis (10).

Left and right hand grips (98, 100) connect to the lower arm bars via lower arm yaw joints at (102, 104) which allow the hand grips to turn about the vertical axis. Grip pitch joints at (106, 108) allow the hand grips to rotate about the latitudinal axis. The combination of the mid arm roll joints, lower arm yaw joints and grip pitch joints gives the hand grips a sufficient degree of freedom to simulate most normal human hand and wrist rotations. In alternate embodiments, the aforementioned mid arm roll, lower arm yaw and grip pitch joints are replaced by a single ball and socket joint.

Each hand grip consists of a gripping surface (110) and four independent trigger mechanisms (112). The gripping surface is grasped by the palm of the hand while the fingers wrap around the triggers. In a preferred embodiment, the gripping surface is constructed of lightweight metal or plastic coated with a course rubber surface to improve grip. Each trigger mechanism can be squeezed independently throughout a short range of motion. Although the hand grip of a preferred embodiment contains four trigger mechanisms, alternate embodiments may contain various other configurations. One alternate embodiment contains a single trigger mechanism extending the length of the gripping surface that is squeezed by all four fingers. Another embodiment has a solid gripping surface with no trigger mechanisms. In a preferred embodiment, a lightweight, flexible strap attached at the top and bottom of the gripping surface may be included to help secure the operator's hand during exaggerated motions. A grip extension (114) extrudes from each hand grip. A corresponding depression at the bottom of each gripping surface allows the two hand grips to be loosely joined one atop the other. This is useful in simulating two-handed athletic movements such as swinging a baseball bat or golf club.

A head mounted display assembly (26) comprising a head mounted display device and a positioning assembly (132) is connected to the back plate by positioning roll and yaw joints (122, 124). The positioning roll joint (122) pivots about the longitudinal axis while the pitch joint (124) pivots on the latitudinal axis. An extension joint at (126) also pivots around the latitudinal axis and enables the extension and distension of the positioning assembly. The combination of the positioning roll, pitch and extension joints allows the head mounted display device to be moved freely within a limited area above the central frame. A head mounted display device is attached to the positioning assembly by a rotational pitch, roll, and yaw joint. The rotational pitch joint (134) rotates about the latitudinal axis while the roll (136) and yaw (138) joints rotate about the longitudinal and vertical axes respectively. The three opposing rotational joints (pitch, roll, and yaw) allow the head mounted display device to be rotated to substantially any chosen orientation. In an alternate embodiment, the rotational joints are replaced by a single ball and socket joint.

The head mounted display device consists of a wearable helmet (140) and an attached visor (142). The helmet, in a preferred embodiment, is constructed from a rigid, lightweight material with openings, similar to a bicycle helmet, to increase airflow and moderate temperature. An adjustable strap may also be attached to the helmet to provide a more secure fit. The visor (142), attached to the front of the helmet, extends over the operator's eyes providing an electronically generated image. In a preferred embodiment, the visor (142) provides a stereo image comprised of a separate image for each eye. In alternate embodiments, however, the visor (142) generates a monocular image. Any of several wearable display technologies, such as LCD and OEL, known to those in the art may be utilized by the aforementioned visor without departing from the scope of the invention. In a preferred embodiment, a binocular display device with a color resolution of 16 bit or higher and a display resolution, for each eye, of 640×480 or higher is employed.

The device described in the detailed description above provides a mechanism allowing an operator to perform any number of natural athletic movements while remaining in a fixed position and, by itself, is beneficial in the field of cardiovascular fitness. It is a further aspect of the present invention, however, to couple the above-detailed device with a computing component to provide interactive feedback to the operator. Electronic sensors, operatively placed at each joint, allow the computing component to determine the position and rotation, in 3D space, of the operator's feet, hands, head and torso. This position and rotation information is processed by a simulation program which, in turn, provides visual data to the operator in real time.

Since most of the joints in the device are simple, single-axis rotation joints, low cost sensing devices may be employed to measure joint rotation. Many examples of electronic, single-axis rotation measurement devices are well known to those in the art including, but not limited to, motion based (inertial) and optical sensors. Although the scope of the invention is not limited to a particular type of sensor device, a preferred embodiment employs digital rotation sensors (with an 8bit or greater accuracy over a 180° range of rotation) that do not require calibration (except possibly an initial, one time calibration when the device is assembled). The sensors in a preferred embodiment should be able to report accurate rotation information with a minimum frequency above ten times a second.

A single sensor placed near the swivel joint between the central frame (2) and the base surface (11) measures the 360° rotation of the central frame (2). Sensors operatively placed at the yaw, roll, pitch, and extension joints of each leg apparatus measure leg motion while sensors at each ankle yaw joint measure foot rotation. In a preferred embodiment, a digital sensor is employed on each adjustable foot assembly to measure the position of said assembly along the lower leg bar. Rotation sensors operatively placed at the yaw, pitch and extension joints of each arm measure hand position while sensors at the mid arm roll, lower arm yaw and grip pitch joints measure hand rotation. A preferred embodiment of the present invention further includes sensors that independently measure the amount of depression of each trigger. Rotation sensors operatively placed at the roll, pitch, and extension joints of the positioning assembly measure head position while sensors at the rotational pitch, yaw and roll joints measure head rotation.

Data from each sensor is fed in serial or in parallel to a computing device. In a preferred embodiment of the present invention, the computing device is located externally to the device. Alternate embodiments, however, place the computing device partially or completely on the device. The computing device runs a simulation program (in hardware, software, or both) to produce interactive visual images. The simulation program receives data from each of the aforementioned sensors and, from said data, calculates the three-dimensional position and rotation of the operator's hands, feet, and head. Some or all of the aforementioned three-dimensional position and rotation information is re-calculated at a rate greater than ten times per second. Said position and rotation information is used by the simulation program to update simulation information, such as a location in an environment or the impact of a tennis racquet, which in turn generates one or more images, at a corresponding rate above 10 Hz, output to the visor. In a preferred embodiment, the simulation program generates a separate image for each eye wherein each image comprises a view taken from a slightly different angle to provide a stereoscopic image for the operator.

While single-axis rotation sensors provide a cost effective and reliable solution for determining three-dimensional position and rotation values, more elaborate positioning methods, such as remote positioning, are also known to those in the art. Remote positioning systems are able to “wirelessly” track the three-dimensional position and rotation of an object. An alternate embodiment of the present invention utilizes a remote positioning system to track the head mounted display. In said alternate embodiment, the positioning assembly is removed and the head mounted display is unconnected (with the possible exception of wiring) to the central frame. In a further alternate embodiment, arm apparatuses are removed and one or both hand grip devices are alternately tracked by a remote positioning system. Although the leg apparatuses provide support for the operator's body weight and friction for turning as well as motion tracking capabilities, alternate embodiments exist wherein the leg apparatuses are removed. In one such alternate embodiment, the operator wears shoes that provide a reduced friction with the base and are tracked by a remote positioning system.

The detailed description presented herein, provides an example of a preferred embodiment of the present invention and is not intended to limit the scope of the present invention to one specific example. Those skilled in the art will recognize that certain modifications may be made to the system presented in the preceding disclosure without departing from the scope of the present invention as defined by the appended claims and their equivalents.

I claim:

1. A simulation device for use by an operator comprising:
a stationary base;
a central frame rotatably connected to the base;
a first foot support rotatable around at least three axes;
a second foot support rotatable around at least three axes;
and an arm support connected to the central frame, whereby the operator is able to rotate the central frame relative to the base.

2. The device of claim 1 further comprising a visual display capable of being connected to the head of the operator.

3. The device of claim 2 further comprising a plurality of sensors operable to detect the relative position and rotation of the visual display, the first and second foot supports, and the arm support.

4. The device of claim 3 further comprising a computing device operatively connected to the plurality of sensors and the visual display wherein said computing device is capable of generating a display signal for the visual display using information provided by the sensors.

5. The device of claim 4 further comprising a second arm support and sensors operable to detect the relative position and rotation of the second arm support wherein said sensors are operatively connected to the computing device.

6. A simulation system comprising:
a motion device for use by an operator allowing the operator to perform the motions of walking, running, and turning while restricting the operator from traveling;
a plurality of sensors operable to detect the relative position and rotation of the operator's feet and head;
a visual display capable of being connected to the operator's head;
and a computing device, operatively connected to the plurality of sensors and the visual display, capable of generating a display signal for the visual display using information provided by the sensors.

7. The system of claim 6 further comprising sensors operable to detect the relative position and rotation of the operator's hands.

8. The system of claim 7 wherein the motion device includes a first and second foot support wherein each foot support is independently rotatable around at least 3 axes.

9. The system of claim 8 wherein the motion device further includes a central frame rotatably connected to a stationary base.

10. The system of claim 9 wherein the motion device further includes a first and second arm support wherein each arm support is independently rotatable around at least three axes.
